(19) United States
(12) Patent Application Publication
(10) Pub. No.: US 2018/0144694 A1
(43) Pub. Date: May 24, 2018

(54) DISPLAY PANEL, DRIVING CIRCUIT AND DRIVING METHOD

(71) Applicant: Shenzhen China Star Optoelectronics Technology Co., Ltd., Shenzhen, Guangdong (CN)

(72) Inventor: Xiaoyu HUANG, Shenzhen, Guangdong (CN)

(73) Assignee: Shenzhen China Star Optoelectronics Technology Co., Ltd., Shenzhen, Guangdong (CN)

(21) Appl. No.: 15/128,985

(22) PCT Filed: Jul. 12, 2016
(86) PCT No.: PCT/CN2016/089795

§ 371 Date: Sep. 25, 2016

(30) Foreign Application Priority Data
May 20, 2016 (CN) 201610344893.0

(51) Int. Cl. G09G 3/36; G02F 1/1362; G02F 1/1343

(52) U.S. Cl. CPC G09G 3/36; G02F 1/1343; G02F 1/136286

(57) ABSTRACT

The present application discloses a display panel, its driving circuit and driving method. A driving circuit of the display panel, including: a scan driving circuit; a scanning line; a control circuit disposed between the scan driving circuit and the scanning line, the first input terminal of the control circuit is connected to the output terminal of the scan driving circuit, the output terminal of the control circuit is connected to the scanning line: when the input signal of the second input terminal of the control circuit is a first control signal, the gate driving signal is output to the scanning line to drive the pixels of the display panel; and when the input signal of the second input terminal of the control circuit is a second control signal, a gate electrode turn-off voltage signal aim to the pixel of the display panel is output to the scanning line.

### BACKGROUND OF THE INVENTION

### 1. Field of the Invention

The present application relates to a liquid crystal display technology field, and more particularly to display panel, driving circuit and driving method.

### 2. Description of the Prior Art

Thin Film Transistor Liquid Crystal Display, TFT-LCD is one of the main varieties of flat panel displays currently, has become an important display platform in modern IT and video products. The main driving principle of TFT-LCD is: the system board makes the R/G/B compressed signal, control signal and power connect to the connector of the PCB through the wire, after the data is processed by the integrated circuit, IC of the timing controller, TCON on the printed circuit board, PCB, is connected to the display area through PCB, the Source-Chip on Film, S-COF and the Gate-Chip on Film, G-COF, so that the LCD obtain the desired power and signal.

The conventional refresh frequency of display panel is 60 Hz, that is, the panel is refreshed 60 times per second, and each refresh is the process of charging and discharging to each display pixel of the display area. When the panel is in the fast moving state (for example, playing video, games, scrolling, etc.), the refresh frequency is necessary; but if it is a static image, it still constantly refreshed, which causing a lot of unnecessary power loss.

### SUMMARY OF THE INVENTION

In order to overcome the insufficient of the conventional technology, an exemplary embodiment of the display panel, and its driving circuit and driving method of the present application is provided without additional cost and reduce the power consumption of the display panel.

A first aspect of the present application provides a driving circuit of the display panel according to an exemplary embodiment, wherein the driving circuit including: a scan driving circuit is for providing a gate driving signal for each pixel in the display panel; a scanning line is connected to each pixel in the display panel; a control circuit is disposed between the scan driving circuit and the scanning line, the first input terminal of the control circuit is connected to the output terminal of the scan driving circuit, the output terminal of the control circuit is connected to the scanning line, wherein the control circuit is configured to: when the input signal of the second input terminal of the control circuit is a first control signal, the gate driving signal provided by the scan driving circuit is output to the scanning line to drive the pixels of the display panel; and when the input signal of the second input terminal of the control circuit is a second control signal, a gate electrode turn-off voltage signal aim to the pixel of the display panel is output to the scanning line.

Alternatively, the control circuit including a first transistor and a second transistor, the gate electrodes of the first transistor and the second transistor are connected to the second input terminal of the control circuit, the source electrode of the first transistor is connected to the output terminal of the scan driving circuit, a drain electrode of the first transistor is connected to a source electrode of the second transistor, a drain electrode of the second transistor is connected to the scanning line and is applied the gate electrode turn-off voltage signal, and when the input signal of the second input terminal of the control circuit is the first control signal, the first transistor is turned on, the second transistor is turned off; when the input signal of the second input terminal of the control circuit is the second control signal, the first transistor is turned off, the second transistor is turned on.

Alternatively, by the comparison of the current frame and the previous frame in accordance with the row of pixels to determine the input signal of the second input terminal of the control circuit is the first control signal or the second control signal.

Alternatively, when the image of the current frame displayed by using the pixel of the ith row and the image of the previous frame displayed by using the pixel of the ith row are different, the input signal of the second input terminal of the control circuit is the first control signal, when the image of the current frame displayed by using the pixel of the ith row and the image of the previous frame displayed by using the pixel of the ith row are the same, the input signal of the second input terminal of the control circuit is the second control signal, wherein, i is an integer, and 1≤i≤the maximum quantity of the rows of the pixel.

Alternatively, the first transistor is a PMOS transistor, the second transistor A2 is an NMOS transistor.

Alternatively, the control circuit is disposed in the fan-out region of the display panel.

Another aspect of the present application provides a driving method of the display panel according to an exemplary embodiment, the display panel including a scan driving circuit, a scanning line and a control circuit disposed between the scan driving circuit and the scanning line, wherein the scanning line is connected to each pixel in the display panel, the first input terminal of the control circuit is connected to the output terminal of the scan driving circuit, the output terminal of the control circuit is connected to the scanning line, wherein the driving method including: when the input signal of the second input terminal of the control circuit is a first control signal, the gate driving signal provided by the scan driving circuit is output to the scanning line to drive the pixels of the display panel; and when the input signal of the second input terminal of the control circuit is a second control signal, a gate electrode turn-off voltage signal aim to the pixel of the display panel is output to the scanning line.

Alternatively, the control circuit including a first transistor and a second transistor, the gate electrodes of the first transistor and the second transistor are connected to the second input terminal of the control circuit, the source electrode of the first transistor is connected to the output terminal of the scan driving circuit, a drain electrode of the first transistor is connected to a source electrode of the second transistor, a drain electrode of the second transistor is connected to the scanning line and is applied the gate electrode turn-off voltage signal, and when the input signal of the second input terminal of the control circuit is the first control signal, the first transistor is turned on, the second transistor is turned off; when the input signal of the second input terminal of the control circuit is the second control signal, the first transistor is turned off, the second transistor is turned on.

Alternatively, by the comparison of the current frame and the previous frame in accordance with the row of pixels to determine the input signal of the second input terminal of the control circuit is the first control signal or the second control signal.

Alternatively, when the image of the current frame displayed by using the pixel of the ith row and the image of the previous frame displayed by using the pixel of the ith row are different, the input signal of the second input terminal of the control circuit is the first control signal, when the image of the current frame displayed by using the pixel of the ith row and the image of the previous frame displayed by using the pixel of the ith row are the same, the input signal of the second input terminal of the control circuit is the second control signal, wherein, i is an integer, and 1≤i≤the maximum quantity of the rows of the pixel.

Alternatively, the first transistor is a PMOS transistor, the second transistor A2 is an NMOS transistor.

The exemplary embodiment of the display panel, and its driving circuit and driving method of the present application can reduce the power consumption of the display panel without additional cost in the same time.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a schematic structure illustrating the driver structure of a display panel according to an exemplary embodiment of the present application.

FIG. 2 is a schematic block diagram illustrating a driving circuit for driving the display panel according to an exemplary embodiment of the present application.

FIG. 3 is a schematic block diagram illustrating a control circuit according to an exemplary embodiment of the present application.

FIG. 4 is a flowchart illustrating a driving method according to an exemplary embodiment of the present application.

FIG. 5 is a schematic structure illustrating the driving method according to an exemplary embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

A driving circuit of a display panel is illustrated according o an exemplary embodiment of the present application, wherein the display panel includes a pixel unit array (referred as pixel) formed by a plurality of pixel unis arranged in an array, and the display panel including at least two regions, i.e., a fan-out region and a display region. Following, in conjunction with FIG. 1 makes detail description of the display panel and the driver structure of the display panel.

FIG. 1 is a schematic structure illustrating the driver structure of a display panel according to an exemplary embodiment of the present application.

As illustrated in FIG. 1, the driver structure of a display panel generally includes: a Printed Circuit Board, PCB, a Source-Chip on Film, S-COF (as S-COF1 to S-COF4 illustrated in FIG. 1, S-COF1 to S-COF4 are collectively referred to as S-COF), a gate-Chip on film, G-COF (as G-COF1 to G-COF4 illustrated in FIG. 1, G-COF1 to G-COF4 are collectively referred to as G-COF) and a display panel 1. The display panel 1 includes a pixel unit array (referred as pixel) formed by a plurality of pixel unis arranged in an array, and the display panel 1 including two regions, a fan-out region 10 and a display region 20 (also referred to as an effective display region).

Referring to FIG. 1, the main driving principle of the driver structure of a display panel shown in FIG. 1 is as follows: The system main board makes the R/G/B compressed signal, control signal and power connect to the connector of the PCB through the wire, after the data is processed by the integrated circuit, IC of the timing controller, TCON on the printed circuit board, PCB, is connected to the display area through PCB, the Source-Chip on Film, S-COF and the Gate-Chip on Film, G-COF, so that the LCD obtain the desired power and signal.

Specifically, the system main board provides driving signal and the control signal to the display panel 1 through the G-COF, the system main board provides another control signal and data signal to the display panel 1 through the S-COF, such that pixels on the display panel 1 to normally display.

Alternatively, the display panel 1 can be a Thin Film Transistor Liquid Crystal Display, TFT-LCD. In this embodiment, the core component of each pixel of the display panel 1 is a thin film transistor, TFT.

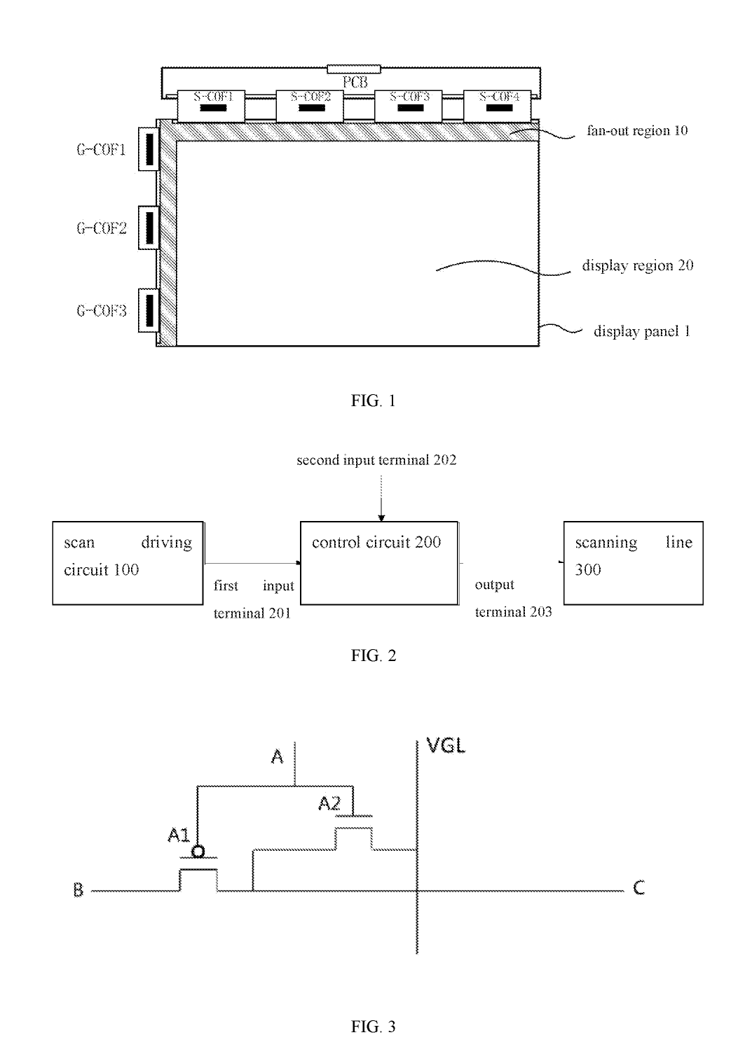

FIG. 2 is a schematic block diagram illustrating a driving circuit for driving the display panel according to an exemplary embodiment of the present application.

As illustrated in FIG. 2, the driving circuit of the display panel according to an exemplary embodiment of the present application includes: a scan driving circuit 100, a control circuit 200 and the a scanning line 300. Further, the scan driving circuit 100 provides a gate driving signal for each pixel in the display panel 1. The scanning line 300 is connected to each pixel in the display panel 1. The control circuit 200 is provided between the scan driving circuit 100 and the scanning line 300, the first input terminal 201 of the control circuit 200 is connected to the output terminal of the scan driving circuit 100, the output terminal 203 of the control circuit 200 is connected to the scanning line 300.

Further, the control circuit 200 is configured to: when the input signal of the second input terminal 202 of the control circuit 200 is a first control signal, the gate driving signal provided by the scan driving circuit 100 is output to the scanning line 300 to drive the pixels of the display panel 1; when the input signal of the second input terminal 202 of the control circuit 200 is a second control signal, a gate electrode turn-off voltage signal is output to the scanning line 300.

FIG. 3 is a schematic block diagram illustrating a control circuit according to an exemplary embodiment of the present application. As illustrated in FIG. 3, the first input terminal of the control circuit 200 is represented as B, the second input terminal of the control circuit 200 is represented as A, the output terminal of the control circuit 200 is represented as C.

Referring to FIG. 3, the control circuit 200 can include a first transistor A1 and a second transistor A2. The gate electrodes of the first transistor A1 and the second transistor A2. are connected to the second input terminal A of the control circuit 200, the source electrode of the first transistor A1 is connected to the output terminal of the scan driving circuit 100, a drain electrode of the first transistor A1 is connected to a source electrode of the second transistor A2, a drain electrode of the second transistor A2 is connected to the scanning line 300 and is applied the gate electrode turn-off voltage signal VGL (as an example, but not limited to −9V) aim to the pixel of the display panel.

In one embodiment, when the input signal of the second input terminal A of the control circuit 200 is the first control signal, the first transistor A1 is turned on, the second transistor A2 is turned off, the control circuit 200 make the scanning driving circuit 100 via the gate electrode driving signal provided by the first input terminal B of the control circuit 200 output to the scanning line 300 through the output terminal C of the control circuit 200, to drive the pixel of the display panel 1. When the input signal of the second input terminal A of the control circuit 200 is the second control signal, the first transistor A1 is turned off, the second transistor A2 is turned on, and the control circuit 200 make the gate electrode turn-off voltage signal VGL output to the scanning line 300 through the output terminal C of the control circuit 200, in this case, the gate electrode driving signal is not output to the scanning line 300, the gate electrode turn-off voltage signal VGL is applied to the respective pixels of the display panel via the scanning line 300, so that the transistors of the pixels are turned off, and the pixels are not refreshed.

In one embodiment, the first transistor A1 is a PMOS transistor, the second transistor A2 is an NMOS transistor. In this embodiment, the first control signal is a low electrical level signal (as an example, but not limited to 0V voltage signal), (the low electrical level signal is turn on voltage of the PMOS transistor and the turn off signal of the NMOS transistor), when the input signal of the second input terminal A of the control circuit 200 is the low electrical level signal, the PMOS transistor A1 is turned on, the NMOS transistor A2 is turned off; the second control signal is a high electrical level signal (as an example, but not limited to 3.3V voltage signal) (the high electrical level signal is the turn on voltage of the NMOS transistor and the turn off signal of the PMOS transistor), when the input signal of the second input terminal A of the control circuit 200 is the high electrical level signal, the PMOS transistor A1 is turned off, the NMOS transistor A2 is turned on.

In another embodiment, the first transistor A1 is an NMOS transistor, the second transistor A2 is a PMOS transistor. In this embodiment, the first control signal is a high electrical level signal (as an example, but not limited to 3.3V voltage signal), when the input signal of the second input terminal A of the control circuit 200 is the high electrical level signal, the NMOS transistor A1 is turned on, the PMOS transistor A2 is turned off; the second control signal is the low electrical level signal, (as an example, but not limited to 0V voltage signal), when the input signal of the second input terminal A of the control circuit 200 is the low electrical level signal, the NMOS transistor A1 is turned off, the PMOS transistor A2 is turned on.

Alternatively, by the comparison of the current frame and the previous frame in accordance with the row of pixels to determine the input signal of the second input terminal A of the control circuit 200 is the first control signal or the second control signal.

Alternatively, when the image of the current frame displayed by using the pixel of the ith row and the image of the previous frame displayed by using the pixel of the ith row are different, the input signal of the second input terminal A of the control circuit 200 is the first control signal. When the image of the current frame displayed by using the pixel of the ith row and the image of the previous frame displayed by using the pixel of the ith row are the same, the input signal of the second input terminal A of the control circuit 200 is the second control signal, wherein, i is an integer, and 1≤i≤the maximum quantity of the rows of the pixel.

Alternatively, in conjunction with FIG. 1, the control circuit 200 as described above can be disposed on the fan-out region 10 of the display panel 1 as illustrated in FIG. 1. Preferably, the control circuit 200 as described above can be provided on the G-COF side of the fan-out region 10 of the display panel 1 as illustrated in FIG. 1.

Alternatively, the second input terminal of the control circuit 200 can be connected to the output terminal of the TCON.

Alternatively, the driving circuit as described above can be a GOA type driving circuit.

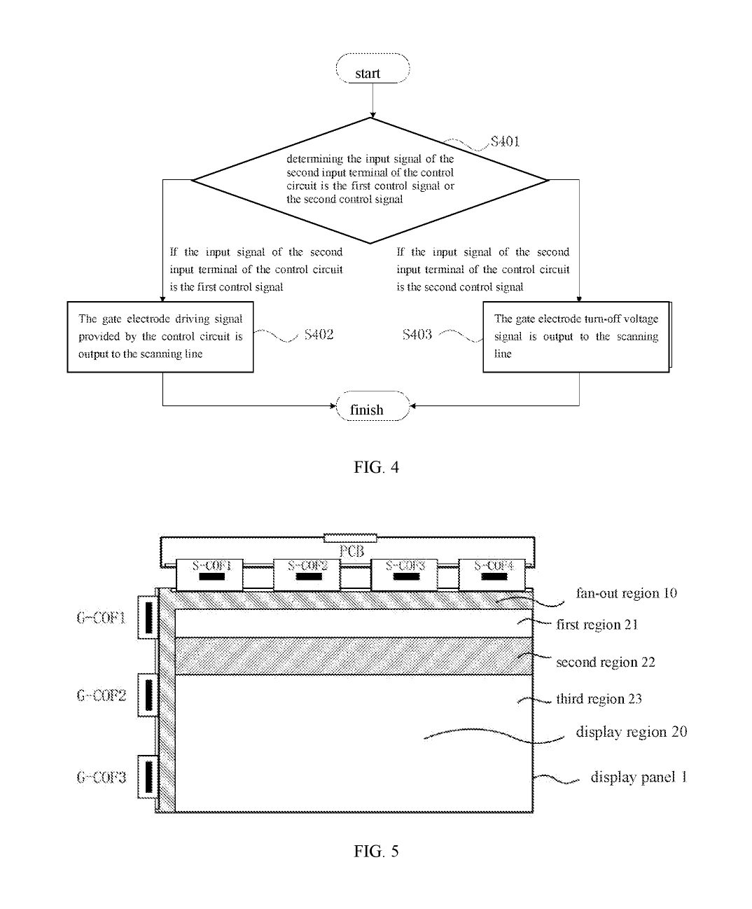

According to another aspect of the exemplary embodiment of the present application provides a driving method of the display panel. The display panel includes: a scan driving circuit, a scanning line and a control circuit disposed between the scan driving circuit and the scanning line. The scan driving circuit provides gate electrode driving signal to each pixel of the display panel, the, the scanning lines are connected to each pixel of the display panel, the first input terminal of the control circuit is connected to the output terminal of the scan driving circuit, the output of the control circuit is connected to the scanning line. Following, the driving method of the display panel according to an exemplary embodiment of the present application is specifically described in conjunction with FIG. 4.

FIG. 4 is a flowchart illustrating a driving method according to an exemplary embodiment of the present application.

As illustrated in FIG. 4, in step S401, determining the input signal of the second input terminal of the control circuit is the first control signal or the second control signal. If the input signal of the second input terminal of the control circuit is the first control signal, in step S402, the gate electrode driving signal provided by the control circuit is output to the scanning line to drive the pixels of the display panel. If the input signal of the second input terminal of the control circuit is the second control signal, in step S403, the gate electrode turn-off voltage signal is output to the scanning line.

Alternatively, the control circuit can include a first transistor and a second transistor. The gate electrodes of the first transistor and the second transistor are connected to the second input terminal of the control circuit, the source electrode of the first transistor is connected to the output terminal of the scan driving circuit, a drain electrode of the first transistor is connected to a source electrode of the second transistor, a drain electrode of the second transistor is connected to the scanning line and is applied the gate electrode turn-off voltage signal (as an example, but not limited to −9V).

In one embodiment, when the input signal of the second input terminal of the control circuit is the first control signal, the first transistor is turned on, the second transistor is turned off, and the control circuit output the gate electrode driving signal provided by scanning driving circuit to the scanning line to drive the pixel of the display panel. When the input signal of the second input terminal of the control circuit is the second control signal, the first transistor is turned off, the second transistor is turned on, and the control circuit output the gate electrode turn-off voltage signal to the scanning line, in this case, the gate electrode driving signal is not output to the scanning line, the gate electrode turn-off voltage signal is applied to the respective pixels of the display panel via the scanning line, so that the transistors of the pixels are turned off, and the pixels are not refreshed.

In one embodiment, the first transistor is a PMOS transistor, the second transistor is an NMOS transistor. In this embodiment, the first control signal is a low electrical level signal (as an example, but not limited to 0V voltage signal), when the input signal of the second input terminal of the control circuit is the low electrical level signal, the PMOS transistor is turned on, the NMOS transistor is turned off; the second control signal is a high electrical level signal (as an example, but not limited to 3.3V voltage signal), when the input signal of the second input terminal of the control circuit is the high electrical level signal, the PMOS transistor is turned off, the NMOS transistor is turned on.

In another embodiment, the first transistor is an NMOS transistor, the second transistor is a PMOS transistor. In this embodiment, the first control signal is a high electrical level signal (as an example, but not limited to 3.3V voltage signal), when the input signal of the second input terminal A of the control circuit is the high electrical level signal, the NMOS transistor is turned on, the PMOS transistor is turned off; the second control signal is the low electrical level signal, (as an example, but not limited to 0V voltage signal), when the input signal of the second input terminal of the control circuit is the low electrical level signal, the NMOS transistor is turned off, the PMOS transistor is turned on.

Alternatively, in step S401, by the comparison of the current frame and the previous frame in accordance with the row of pixels to determine the input signal of the second input terminal of the control circuit is the first control signal or the second control signal. Alternatively, when the image of the current frame displayed by using the pixel of the ith row and the image of the previous frame displayed by using the pixel of the ith row are different, the input signal of the second input terminal of the control circuit is the first control signal. When the image of the current frame displayed by using the pixel of the ith row and the image of the previous frame displayed by using the pixel of the ith row are the same, the input signal of the second input terminal of the control circuit is the second control signal, wherein, i is an integer, and 1≤i≤the maximum quantity of the rows of the pixel.

Hereinafter, in conjunction with specific embodiments to more specifically illustration the driving method of the display panel above.

FIG. 5 is a schematic structure illustrating the driving method according to an exemplary embodiment of the present application.

As illustrated in FIG. 5, a display region 20 of the display panel 1 includes three sub-regions, such as a first region 21, a second region 22 and a third region 23. In the embodiment, in the process of display the image or video, changes are occurred in the images displayed in the first region 21 and the third region 23 are changed, the image displayed in the display region 22 is not changed. That is, the image of the current frame displayed by using the row of the pixel in the first region 21 and the image of the previous frame displayed by using the corresponding row of the pixel in the first region 21 are different, the image of the current frame displayed by using the row of the pixel in the second region 22 and the image of the previous frame displayed by using the corresponding row of the pixel in the second region 22 are the same, the image of the current frame displayed by using the row of the pixel in the third region 23 and the image of the previous frame displayed by using the corresponding row of the pixel in the third region 23 are different.

Further, the number of rows of the pixel in the first region 21, the second region 22 and the third region 23 are equal to or greater than 1. Alternatively, assuming that the number of rows of the pixel in the three regions are greater than 1, the image of the current frame displayed by using the each row of the pixel in the first region 21 and the image of the previous frame displayed by using the corresponding rows of the pixel in the first region 21 are different, the image of the current frame displayed by using the each row of the pixel in the second region 22 and the image of the previous frame displayed by using the corresponding rows of the pixel in the second region 22 are the same, the image of the current frame displayed by using the each row of the pixel in the third region 23 and the image of the previous frame displayed by using the corresponding rows of the pixel in the third region 23 are different.

Referring to FIG. 5, the display panel illustrated in FIG. 5 includes the driving circuit illustrated above with reference to FIG. 3. The first input terminal B of the control circuit is connected to the output terminal of the G-COF (i.e., the scan driving circuit), the output terminal C of the control circuit is connected to the scanning lines. In this embodiment, it is assumed the first transistor A1 is a PMOS transistor, the second transistor A2 is an NMOS transistor, and the first control signal is a low electrical level signal (as an example, but not limited to 0V voltage signal), the second control signal is a high electrical level signal (as an example, but not limited to 3.3V voltage signal).

Further, when the gate electrode signal scans to the first region 21, since the image of the current frame displayed by using the row of the pixel in the first region 21 and the image of the previous frame displayed by using the corresponding row of the pixel in the first region 21 are different, the input signal of the second input terminal of the control circuit is the first control signal. By the low electrical level signal of the first control signal, the PMOS transistor A1 is turned on, the NMOS transistor A2 is turned off, this time, the gate electrode driving signal provided by the G-COF is output to the scanning lines through the output terminal C of the control circuit to drive each pixel in the first region 21 (i.e., each pixel in the first region 21 is normal refreshed).

When the gate electrode signal scans to the second region 22, since the image of the current frame displayed by using the row of the pixel in the second region 22 and the image of the previous frame displayed by using the corresponding row of the pixel in the second region 22 are the same, the input signal of the second input terminal of the control circuit is the second control signal. By the high electrical level signal of the second control signal, the PMOS transistor A1 is turned off, the NMOS transistor A2 is turned on, this time, the gate electrode driving signal provided by the G-COF cannot be output to the scanning lines through the output terminal C of the control circuit, alternatively, the gate electrode turn-off voltage signal VGL is output to the scanning line through the output terminal C of the control circuit, each pixel of the second region 22 is not refreshed.

Similarly to the first region 21, when the gate electrode signal scans to the third region 23, since the image of the current frame displayed by using the row of the pixel in the third region 23 and the image of the previous frame displayed by using the corresponding row of the pixel in the third region 23 are different, the input signal of the second input terminal of the control circuit is the first control signal. By the low electrical level signal of the first control signal, the PMOS transistor A1 is turned on, the NMOS transistor A2 is turned off, this time, the gate electrode driving signal provided by the G-COF is output to the scanning lines through the output terminal C of the control circuit to drive each pixel in the third region 23 (i.e., each pixel in the third region 23 is normal refreshed).

Alternatively, the second input terminal of the control circuit can be connected to the output terminal of TCON. TCON can store the image of the previous frame, and comparing the image of the current frame and the image of the previous frame according to the pixel rows.

In addition, by the utilization of the combination circuit of at least two transistors according to the display panel, the driving circuit thereof and the driving method of the exemplary embodiment of the present invention to achieve a dynamic regional selective refresh, and reduce the power consumption of the display panel without additional costs at the same time.

Above are embodiments of the present application, which does not limit the scope of the present application. Any modifications, equivalent replacements or improvements within the spirit and principles of the embodiment described above should be covered by the protected scope of the invention.

What is claimed is:

1. A driving circuit of the display panel, comprising:
a scan driving circuit is for providing a gate driving signal for each pixel in the display panel;
a scanning line is connected to each pixel in the display panel;
a control circuit is disposed between the scan driving circuit and the scanning line, the first input terminal of the control circuit is connected to the output terminal of the scan driving circuit, the output terminal of the control circuit is connected to the scanning line, wherein the control circuit is configured to:
when the input signal of the second input terminal of the control circuit is a first control signal, the gate driving signal provided by the scan driving circuit is output to the scanning line to drive the pixels of the display panel; and
when the input signal of the second input terminal of the control circuit is a second control signal, a gate electrode turn-off voltage signal aim to the pixel of the display panel is output to the scanning line.

2. The driving circuit according to claim 1, wherein the control circuit comprising a first transistor and a second transistor, the gate electrodes of the first transistor and the second transistor are connected to the second input terminal of the control circuit, the source electrode of the first transistor is connected to the output terminal of the scan driving circuit, a drain electrode of the first transistor is connected to a source electrode of the second transistor, a drain electrode of the second transistor is connected to the scanning line and is applied the gate electrode turn-off voltage signal, and when the input signal of the second input terminal of the control circuit is the first control signal, the first transistor is turned on, the second transistor is turned off; when the input signal of the second input terminal of the control circuit is the second control signal, the first transistor is turned off, the second transistor is turned on.

3. The driving circuit according to claim 1, wherein by the comparison of the current frame and the previous frame in accordance with the row of pixels to determine the input signal of the second input terminal of the control circuit is the first control signal or the second control signal.

4. The driving circuit according to claim 3, wherein when the image of the current frame displayed by using the pixel of the ith row and the image of the previous frame displayed by using the pixel of the ith row are different, the input signal of the second input terminal of the control circuit is the first control signal, when the image of the current frame displayed by using the pixel of the ith row and the image of the previous frame displayed by using the pixel of the ith row are the same, the input signal of the second input terminal of the control circuit is the second control signal, wherein, i is an integer, and 1≤i≤the maximum quantity of the rows of the pixel.

5. The driving circuit according to claim 2, wherein the first transistor is a PMOS transistor, the second transistor A2 is an NMOS transistor.

6. The driving circuit according to claim 3, wherein the first transistor is a PMOS transistor, the second transistor A2 is an NMOS transistor.

7. The driving circuit according to claim 4, wherein the first transistor is a PMOS transistor, the second transistor A2 is an NMOS transistor.

8. A display panel, wherein the display panel comprising a driving circuit, and the driving circuit comprising:
a scan driving circuit is for providing a gate driving signal for each pixel in the display panel;
a scanning line is connected to each pixel in the display panel;
a control circuit is disposed between the scan driving circuit and the scanning line, the first input terminal of the control circuit is connected to the output terminal of the scan driving circuit, the output terminal of the control circuit is connected to the scanning line, wherein the control circuit is configured to:
when the input signal of the second input terminal of the control circuit is a first control signal, the gate driving signal provided by the scan driving circuit is output to the scanning line to drive the pixels of the display panel; and
when the input signal of the second input terminal of the control circuit second control signal, a gate electrode turn-off voltage signal the pixel of the display panel is output to the scanning line.

9. A driving method of the display panel, wherein the display panel comprising a scan driving circuit, a scanning line and a control circuit disposed between the scan driving circuit and the scanning line, wherein the scanning line is connected to each pixel in the display panel, the first input terminal of the control circuit is connected to the output terminal of the scan driving circuit, the output terminal of the control circuit is connected to the scanning line, wherein the driving method comprising:
when the input signal of the second input terminal of the control circuit is a first control signal, the gate driving signal provided by the scan driving circuit is output to the scanning line to drive the pixels of the display panel; and
when the input signal of the second input terminal of the control circuit is a second control signal, a gate electrode turn-off voltage signal aim to the pixel of the display panel is output to the scanning line.

10. The driving method according to claim 9, wherein the control circuit comprising a first transistor and a second transistor, the gate electrodes of the first transistor and the second transistor are connected to the second input terminal of the control circuit, the source electrode of the first transistor is connected to the output terminal of the scan driving circuit, a drain electrode of the first transistor is connected to a source electrode of the second transistor, a drain electrode of the second transistor is connected to the scanning line and is applied the gate electrode turn-off voltage signal, and when the input signal of the second input terminal of the control circuit is the first control signal, the first transistor is turned on, the second transistor is turned off; when the input signal of the second input terminal of the control circuit is the second control signal, the first transistor is turned off, the second transistor is turned on.

11. The driving method according to claim 9, wherein by the comparison of the current frame and the previous frame in accordance with the row of pixels to determine the input signal of the second input terminal of the control circuit is the first control signal or the second control signal.

12. The driving method according to claim 11, wherein when the image of the current frame displayed by using the pixel of the ith row and the image of the previous frame displayed by using the pixel of the ith row are different, the input signal of the second input terminal of the control circuit is the first control signal, when the image of the current frame displayed by using the pixel of the ith row and the image of the previous frame displayed by using the pixel of the ith row are the same, the input signal of the second input terminal of the control circuit is the second control signal, wherein, i is an integer, and 1≤i≤the maximum quantity of the rows of the pixel.
